(19) United States
(12) Patent Application Publication
(10) Pub. No.: US 2014/0171300 A1
(43) Pub. Date: Jun. 19, 2014

(54) GAS PURIFYING CATALYST FOR INTERNAL COMBUSTION ENGINE

(71) Applicant: Hyundai Motor Company, Seoul (KR)

(72) Inventors: Cheol Beom Lim, Seoul (KR); Yoon Sang Nam, Gunpo-si (KR); Jin Woo Choung, Suwon-si (KR); Youngil Song, Seongnam-si (KR)

(73) Assignee: Hyundai Motor Company, Seoul (KR)

(21) Appl. No.: 13/912,988

(22) Filed: Jun. 7, 2013

(30) Foreign Application Priority Data
Dec. 13, 2012 (KR) 10-2012-0145732

(51) Int. Cl. B01J 23/63

(52) U.S. Cl. CPC B01J 23/63
USPC 502/303; 502/304

(57) ABSTRACT

A gas purifying catalyst for an internal combustion engine may include a carrier, and a catalyst layer formed on the carrier, wherein the catalyst layer has a first catalyst including a first support including alumina and Pd supported in the first support, and a second catalyst including a second support including complex oxide of ceria-zirconia and Rh supported in the second support.

### CROSS-REFERENCE TO RELATED APPLICATION

The present application claims priority to Korean Patent Application No. 10-2012-0145732 filed on Dec. 13, 2012, the entire contents of which is incorporated herein for all purposes by this reference.

### BACKGROUND OF THE INVENTION

1. Field of the Invention

The present invention relates to a gas purifying catalyst for an internal combustion engine.

2. Description of Related Art

Recently, studies of removing contaminant materials included in exhaust gas exhausted from internal combustion engines of vehicles or the like have been actively conducted in view of protection of the global environment.

Examples of the contaminant materials included in the exhaust gas include carbon monoxides (CO), hydrocarbons (HC), nitrogen oxides (NOₓ), or the like, and a three way catalyst, which may simultaneously oxidize and reduce three harmful materials of carbon monoxides, hydrocarbons, and nitrogen oxides to purify the materials, is extensively used in order to convert the contaminant materials into harmless materials.

The three way catalyst is exposed to a high temperature environment, and is required to have high heat resistance because the catalyst needs to be operated under the high temperature environment.

Further, since the three way catalyst is used under the high temperature environment, in the case where the three way catalyst is used while being carried in the same carrier, there is a problem in that noble metals used in a catalyst layer in the three way catalyst form alloys to reduce activity thereof. As illustrated in FIG. 1A, currently, a technology of using a double layer structure constituted by a lower layer where noble metal Pd 52 is carried in a first support 40 and a upper layer where Rh 54 is carried in a second support 42 is generally applied in order to prevent the problem. As illustrated in FIG. 1B, when the catalyst of the double layer structure is used at high temperatures, Pd and Rh separately exist in the lower layer and the upper layer, and thus alloying thereof does not occur.

However, the double layer structure technology has a problem in that manufacturing costs are increased, and thus a single layer catalyst technology is proposed.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a gas purifying catalyst for an internal combustion engine, which is used at high temperatures without a deterioration in activity by improving high temperature durability.

In an aspect of the present invention, a gas purifying catalyst for an internal combustion engine may include a carrier, and a catalyst layer formed on the carrier, wherein the catalyst layer may include a first catalyst including a first support including alumina and Pd supported in the first support, and a second catalyst including a second support including complex oxide of ceria-zirconia and Rh supported in the second support.

The first support may further include La, wherein a content of the La is 0.5 wt % to 5 wt % based on 100 wt % of an entire first support including the alumina and the La, wherein the second support may further include an additive selected from La, Nd, Si, Pr, or a combination thereof, and wherein a content of the additive is 1 wt % to 20 wt % based on 100 wt % of an entire second support including the ceria, the zirconia, and the additive.

The second support may include 20 wt % to 70 wt % of ceria and 80 wt % to 30 wt % of zirconia.

The second support may further include an additive selected from La, Nd, Si, Pr, or a combination thereof, wherein a content of the additive is 1 wt % to 20 wt % based on 100 wt % of an entire second support including the ceria-zirconia and the additive.

A mixing ratio of the first catalyst and the second catalyst is 60:40 wt % to 40:60 wt %.

A loading amount of the Pd is 1 wt % to 4 wt % based on 100 wt % of an entire first support.

A loading amount of the Rh is 0.1 wt % to 1 wt % based on 100 wt % of an entire second support.

The catalyst is a single layer.

According to an exemplary embodiment of the present invention, a gas purifying catalyst for an internal combustion engine has excellent heat resistance and alloying of noble metals thereof is suppressed when the gas purifying catalyst is sintered at high temperatures, thus exhibiting excellent catalytic activity.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIGS. 1A and 1B are views schematically illustrating a catalyst structure of a double layer structure in the related art.

FIGS. 2A and 2B are views schematically illustrating a catalyst structure according to an exemplary embodiment of the present invention.

FIGS. 3A and 3B are views schematically illustrating a catalyst structure of a single layer structure in the related art.

FIG. 4 is a graph obtained by measuring a conversion efficiency of contaminant materials of catalysts prepared according to Example 1 and Comparative Examples 1 and 2.

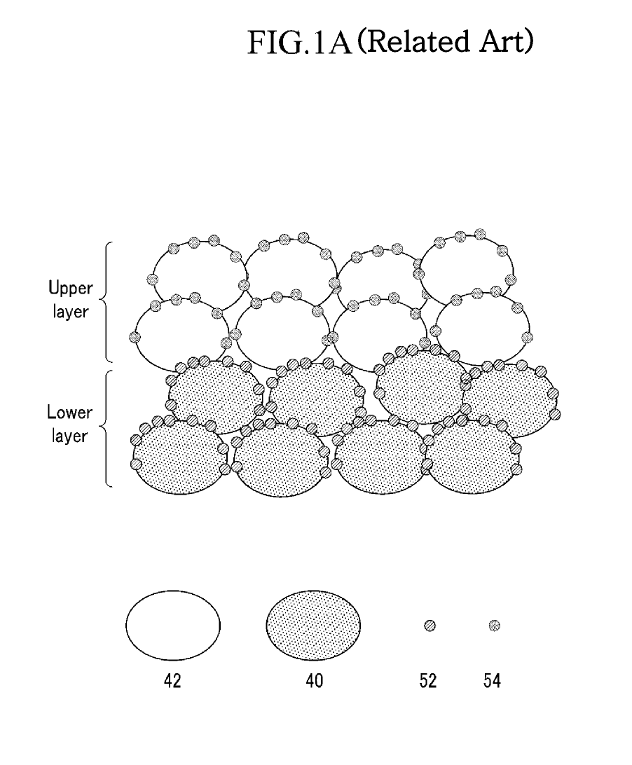

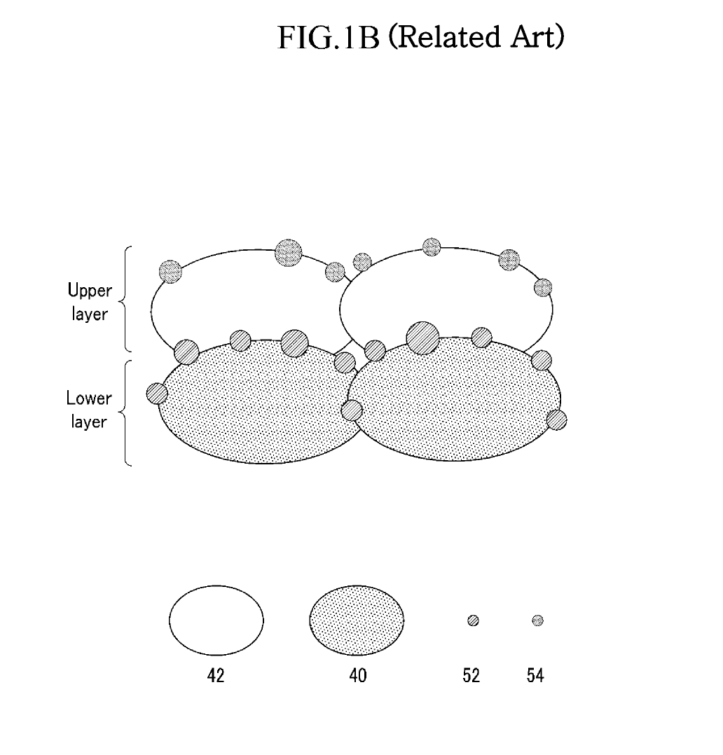

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, an exemplary embodiment of the present invention will be described in detail. However, the exemplary embodiment is illustrative only but is not to be construed to limit the present invention, and the present invention is just defined by the scope of the claims as described below.

A gas purifying catalyst for an internal combustion engine according to an exemplary embodiment of the present invention includes a carrier and a catalyst layer formed on the carrier, in which the catalyst layer includes a first catalyst including a first support including alumina and Pd supported in the first support, and a second catalyst including a second support including complex oxide of ceria-zirconia and Rh supported in the second support. The catalyst layer may be represented by a wash-coat layer.

That is, the catalyst layer of the present invention is a single layer and includes the first catalyst and the second catalyst in one layer, and Pd and Rh, which are active metals of the first catalyst and the second catalyst, are supported in different supports, and thus, even though the catalyst is used at high temperatures, a phenomenon where the active metals are bonded to each other to cause alloying may be prevented, and thus an alloying phenomenon is insignificant. Accordingly, in the case where the gas purifying catalyst for the internal combustion engine is used at high temperatures, deterioration in catalytic activity caused by alloying of active metals may be suppressed, and thus, the gas purifying catalyst for the internal combustion engine according to the exemplary embodiment of the present invention has excellent heat resistance.

In the exemplary embodiment of the present invention, the first support includes alumina, and in this case, [symbol] -alumina may be appropriately used as the alumina.

The first support may further include La together with alumina. In this case, La may exist by being doped in alumina. In the case where the first support further includes La, heat resistance may be further improved. In this case, a content of La may be 0.5 wt % to 5 wt % based on 100 wt % of the entire first support including alumina and La. In the case where the content of La is included in the aforementioned range, there is a merit in that an effect of improving heat resistance is more improved.

The second support may include 20 wt % to 70 wt % of ceria and 80 wt % to 30 wt % of zirconia. In the case where the contents of ceria and zirconia in the second support are included in the aforementioned range, optimum oxygen storing capacity (OSC) performance may be obtained.

The second support may further include an additive selected from La, Nd, Si, Pr, or a combination thereof. In the case where the second support further includes the additive, heat resistance may be further increased. Particularly, Pr may improve the oxygen storage capacity as well as heat resistance of the support.

In this case, a content of the additive may be 1 wt % to 20 wt % based on 100 wt % of the entire second support (i.e., based on 100 wt % of all of ceria, zirconia, and additive). In the case where the content of the additive is less than 1 wt % or more than 20 wt %, there may be problems in that the oxygen storage capacity of the second support deteriorates and costs are increased.

In the exemplary embodiment of the present invention, a mixing ratio of the first catalyst and the second catalyst may be 60:40 wt % to 40:60 wt %. In another exemplary embodiment of the present invention, the mixing ratio of the first catalyst and the second catalyst may be 60:40 wt % to 70:30 wt %.

Further, in the catalyst according to the exemplary embodiment of the present invention, a loading amount of Pd may be 1 wt % to 4 wt % based on 100 wt % of the entire first support, and a loading amount of Rh may be 0.1 wt % to 1 wt % based on 100 wt % of the entire second support.

In the case where the loading amount of Pd and the loading amount of Rh are included in the aforementioned range, more optimal effect may be obtained economically.

In the gas purifying catalyst for the internal combustion engine according to the exemplary embodiment of the present invention, any carrier such as a pellet type carrier, a ceramic monolith type carrier, or a metal wire carrier may be used as a carrier supporting the catalyst layer as long as the carrier is used in the gas purifying catalyst for the internal combustion engine.

The material constituting the carrier may be a ceramic material such as cordierite (2MgO₂··2Al₂O₃··5SiO₂), SiC (silicon carbide), or aluminum titanate.

As the type of the carrier, the ceramic monolith type carrier may be appropriately used.

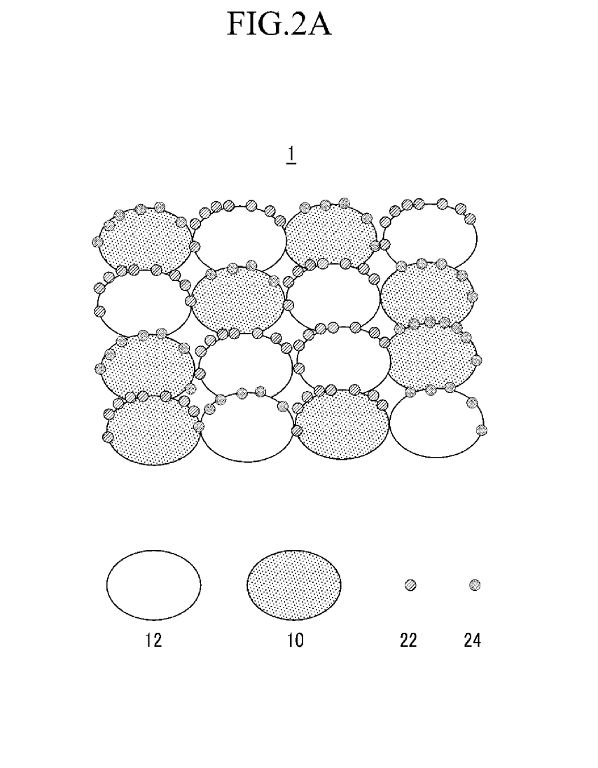

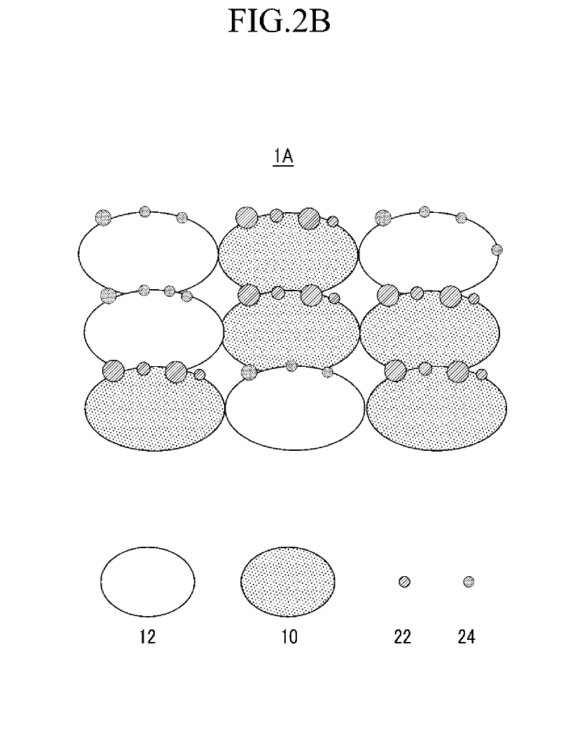

The gas purifying catalyst for the internal combustion engine having the constitution according to the exemplary embodiment of the present invention is schematically illustrated in FIG. 2A. As illustrated in FIG. 2A, a gas purifying catalyst 1 for the internal combustion engine is constituted by a first catalyst including a first support 10 including alumina and Pd 22 supported in the first support 10, and a second catalyst including a second support 12 including complex oxide of ceria-zirconia and Rh 24 supported in the second support 12.

Even though the catalyst is used at high temperatures, as illustrated in FIG. 2B, it can be seen that in a gas purifying catalyst 1A for the internal combustion engine, Pd and Rh are supported in different supports, and thus alloying hardly occurs.

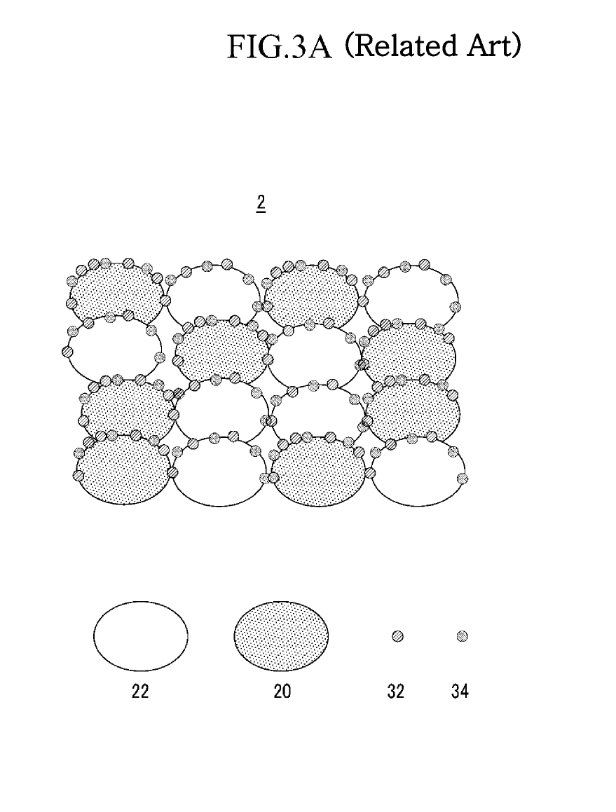

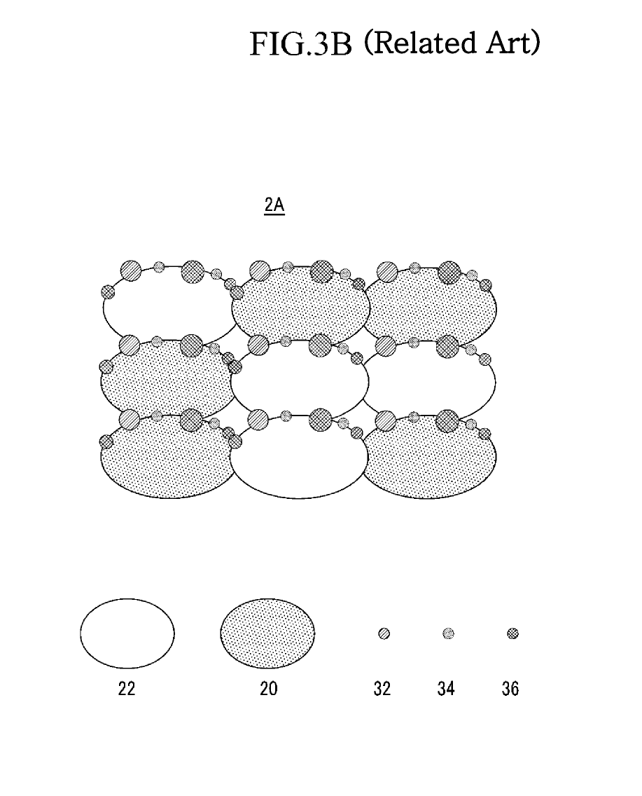

In this regard, it can be seen that when a catalyst 2 of the related art constituted by a single layer and including Pd 32 and Rh 34 carried together in an alumina support 20 and a ceria-zirconia support 22 (FIG. 3A) is used at high temperatures, as illustrated in FIG. 3B, a Pd-Rh alloy 36 is formed in an excessive amount in a catalyst 2A.

In the gas purifying catalyst for the internal combustion engine having the aforementioned constitution according to the exemplary embodiment of the present invention, first, the first catalyst and the second catalyst are mixed with each other, and the mixture is added to water, thereby preparing a slurry type composition by an impregnation process. Subsequently, the composition is applied on the carrier, dried, and fired to prepare the gas purifying catalyst. The firing process is performed at 400° C. to 600° C. for 2 hours to 5 hours.

Hereinafter, Examples and Comparative Examples of the present invention will be described. The following Example is only the preferred Example of the present invention, but the present invention is not limited to the following Example.

### EXAMPLE 1

Pd was supported in a first support including alumina by an impregnation method to prepare the first catalyst. A support including alumina and La was used as the first support, and in this case, a support where the content of La was 4 wt % based on 100 wt % of the entire first support was used. The loading amount of Pd was 2.35 wt % based on 100 wt % of the entire first support.

Rh was supported in a second support including complex oxide of ceria-zirconia by the impregnation method to prepare a second catalyst. In this case, the content of ceria was 23 wt % and the content of zirconia was 77 wt % in the second support. The loading amount of Rh was 0.1 wt % based on 100 wt % of the entire second support.

The first catalyst and the second catalyst were mixed at the ratio of 60:40 wt %, and the mixture was added to water, thereby obtaining a slurry by the impregnation method. The slurry was applied on a cordierite monolith carrier, dried, and fired at 500° C. for 2 hours to produce a catalyst for purifying gas, in which a catalyst layer was formed of a single layer.

### COMPARATIVE EXAMPLE 1

Pd was supported in a first support including alumina by an impregnation method to prepare a first catalyst. A support including alumina and La was used as the first support, and in this case, a support where the content of La was 4 wt % based on 100 wt % of all of alumina and La was used. The loading amount of Pd was 2.5 wt % based on 100 wt % of the entire first support.

Rh was supported in a second support including complex oxide of ceria-zirconia by the impregnation method to prepare a second catalyst. In this case, the content of ceria was 23 wt % and the content of zirconia was 77 wt % in the second support. The loading amount of Rh was 0.1 wt % based on 100 wt % of the entire second support.

A slurry was manufactured by the impregnation method of adding the first catalyst to water. The slurry was applied on a cordierite monolith carrier, dried, and fired at 500° C. for 2 hours to manufacture a lower layer.

Subsequently, a slurry was manufactured by the impregnation method of adding the second catalyst to water. The slurry was applied on the lower layer, dried, and fired at 500° C. for 2 hours to form an upper layer, thus producing a catalyst for purifying gas, in which a catalyst layer was formed of the double layer.

### COMPARATIVE EXAMPLE 2

Pd and Rh were supported in a first support including alumina by an impregnation method to prepare a first catalyst. A support including alumina and La was used as the first support, and in this case, a support where the content of La was 4 wt % based on 100 wt % of the entire first support was used. The loading amount of Pd and Rh was 1.55 wt % based on 100 wt % of the entire first support (loading amount of Pd: 1.5 wt % and loading amount of Rh: 0.05 wt %).

Pd and Rh were supported in a second support including complex oxide of ceria-zirconia by the impregnation method to produce a second catalyst. In this case, the content of ceria was 23 wt % and the content of zirconia was 77 wt % in the second support. The loading amount of Pd and Rh was 0.91 wt % based on 100 wt % of the entire second support (loading amount of Pd:, 0.86 wt % and loading amount of Rh:, 0.05 wt %).

The first catalyst and the second catalyst were mixed at the ratio of 60:40 wt %, and a slurry was manufactured by the impregnation method of adding the mixture to water. The slurry was applied on a cordierite monolith carrier, dried, and fired at 500° C. for 2 hours to produce a catalyst for purifying gas, in which a catalyst layer was formed of a single layer.

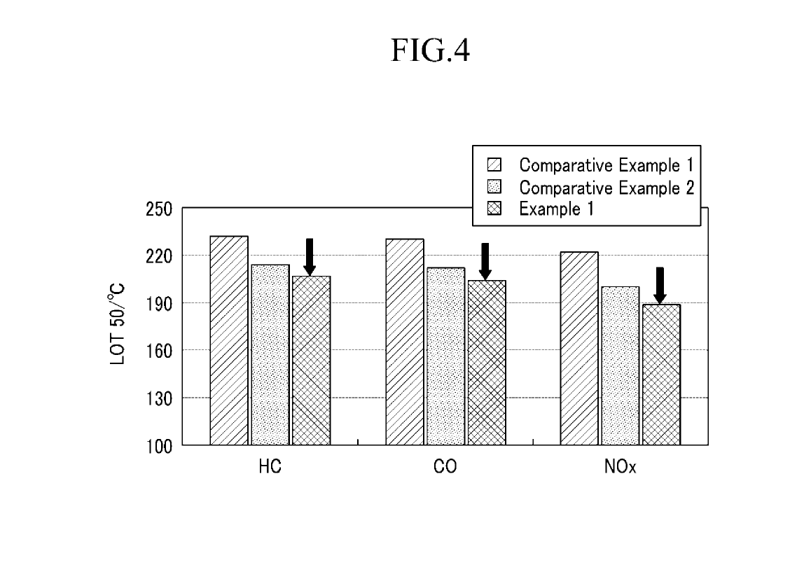

After the catalysts produced according to Example 1 and Comparative Examples 1 and 2 were subjected to hydrothermal treatment of performing heat treatment in water at 1000° C. for 6 hours, the light off temperature to the conversion efficiency of HC, CO, and NOₓ of the catalyst that was subjected to the hydrothermal treatment was measured, and the result thereof is illustrated in FIG. 4. The light off temperature means a temperature of exhaust gas, at which 50% of each contaminant material is converted by a catalyst, and purifying efficiency of the contaminant material is increased as the temperature is reduced.

The light off temperature was obtained by measuring the temperature at which purifying efficiency of HC, CO, and NOₓ that were the contaminant material reached 50% through SIGU2000 (HORIBA) that was a catalytic activity evaluating device. The purifying efficiency of the contaminant material is increased as the light off temperature is reduced.

The light off temperature was measured while injecting gas including N₂ at a space velocity of 67,000 hr⁻¹. Gas including O₂ (concentration:, 0.98 volume %), CO (concentration:, 1.17 volume %), H₂O (concentration:, 10 volume %), CO₂ (concentration:, 13.9 volume %), NO (concentration:, 0.1 volume %), HC (concentration:, 0.3 volume %), and N₂ as the residual was used as the aforementioned gas including N₂.

As illustrated in FIG. 4, it can be seen that since the catalyst of Example 1 reached to the light off temperature at a lower temperature as compared to the catalysts of Comparative Examples 1 and 2, the purifying efficiency of the contaminant material was very excellent during operation at high temperatures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. They are not intended to be exhaustive or to limit the invention to the precise forms disclosed, and obviously many modifications and variations are possible in light of the above teachings as well as various alternatives and modifications thereof. It is intended that the scope of the invention be defined by the Claims appended hereto and their equivalents.

What is claimed is:

1. A gas purifying catalyst for an internal combustion engine, comprising:
a carrier; and
a catalyst layer formed on the carrier, wherein the catalyst layer includes:
a first catalyst including a first support including alumina and Pd supported in the first support; and
a second catalyst including a second support including complex oxide of ceria-zirconia and Rh supported in the second support.

2. The gas purifying catalyst for the internal combustion engine of claim 1, wherein the first support further includes La.

3. The gas purifying catalyst for the internal combustion engine of claim 2, wherein a content of the La is 0.5 wt % to 5 wt % based on 100 wt % of an entire first support including the alumina and the La.

4. The gas purifying catalyst for the internal combustion engine of claim 3, wherein the second support further includes an additive selected from La, Nd, Si, Pr, or a combination thereof.

5. The gas purifying catalyst for the internal combustion engine of claim 4, wherein a content of the additive is 1 wt % to 20 wt % based on 100 wt % of an entire second support including the ceria, the zirconia, and the additive.

6. The gas purifying catalyst for the internal combustion engine of claim 1, wherein the second support includes 20 wt % to 70 wt % of ceria and 80 wt % to 30 wt % of zirconia.

7. The gas purifying catalyst for the internal combustion engine of claim 1, wherein the second support further includes an additive selected from La, Nd, Si, Pr, or a combination thereof.

8. The gas purifying catalyst for the internal combustion engine of claim 7, wherein a content of the additive is 1 wt % to 20 wt % based on 100 wt % of an entire second support including the ceria-zirconia and the additive.

9. The gas purifying catalyst for the internal combustion engine of claim 1, wherein a mixing ratio of the first catalyst and the second catalyst is 60:40 wt % to 40:60 wt %.

10. The gas purifying catalyst for the internal combustion engine of claim 1, wherein a loading amount of the Pd is 1 wt % to 4 wt % based on 100 wt % of an entire first support.

11. The gas purifying catalyst for the internal combustion engine of claim 1, wherein a loading amount of the Rh is 0.1 wt % to 1 wt % based on 100 wt % of an entire second support.

12. The gas purifying catalyst for the internal combustion engine of claim 1, wherein the catalyst is a single layer.
